(19) United States
(12) Patent Application Publication
(10) Pub. No.: US 2024/0202951 A1
(43) Pub. Date: Jun. 20, 2024

(54) DEPTH ESTIMATION METHOD FOR SMALL BASELINE-STEREO CAMERA THROUGH LIDAR SENSOR FUSION

(71) Applicant: Korea Electronics Technology Institute, Seongnam-si (KR)

(72) Inventors: Min Gyu PARK, Seoul (KR); Ju Hong YOON, Hwaseong-si (KR); Min Ho LEE, Namyangju-si (KR); Je Woo KIM, Seongnam-si (KR)

(73) Assignee: Korea Electronics Technology Institute, Seongnam-si (KR)

(21) Appl. No.: 18/539,832

(22) Filed: Dec. 14, 2023

(30) Foreign Application Priority Data
Dec. 20, 2022 (KR) 10-2022-0179004

(51) Int. Cl. G06T 7/593; G01S 17/89; G06V 10/771

(52) U.S. Cl. CPC G06T 7/593; G01S 17/89; G06V 10/771; G06T 2207/20081

(57) ABSTRACT

There is provided a depth estimation method for a small baseline-stereo camera through LiDAR sensor fusion. A depth map estimation method according to an embodiment may estimate a high-resolution depth map from a small baseline-stereo image based on deep learning, by using transfer learning from a deep learning network that is trained to estimate a depth map from a wide baseline-stereo image. Accordingly, in a device which has a small baseline-stereo camera installed therein due to structural constraints, such as a smartphone, a wearable AR/VR device, a drone, 3D image quality can be enhanced. In addition, according to embodiments, pseudo-LiDAR data may be generated by using a depth map estimated from a small baseline-stereo image, and may be used for replacing or reinforcing LiDAR data.

### CROSS-REFERENCE TO RELATED APPLICATION(S) AND CLAIM OF PRIORITY

This application is based on and claims priority under 35 U.S.C. § 119 to Korean Patent Application No. 10-2022-0179004, filed on Dec. 20, 2022, in the Korean Intellectual Property Office, the disclosure of which is herein incorporated by reference in its entirety.

### BACKGROUND

### Field

The disclosure relates to a depth estimation method using a deep-learning network, and more particularly, to a deep learning-based depth estimation method for a stereo camera with a small baseline.

### Description of Related Art

Stereo matching is a technology for estimating a depth map, which matches left and right images and finds corresponding points, and then, estimates a depth map by using disparity (a distance between corresponding points in two images caused by binocular disparity).

In the process of obtaining a depth map from disparity, a baseline between cameras (a distance between two cameras) and a focal length are used. In this process, as a baseline is wider, a depth resolution is higher, but as a baseline is narrower, a depth resolution is lower.

Accordingly, there is a need for a solution for estimating a depth map having a high depth resolution in a small baseline-stereo camera.

### SUMMARY

The disclosure has been developed in order to solve the above-described problem, and an object of the disclosure is to provide a method for estimating a high-resolution depth map based on deep learning in a stereo camera which has a small baseline due to structural constraints, as in a smartphone, a wearable augmented reality (AR)/virtual reality (VR) device, a robot, a drone, etc.

According to an embodiment of the disclosure to achieve the above-described objects, a depth map estimation method may include: a step of extracting feature maps from a left image and a right image by using a first deep learning network; a step of calculating a disparity map by matching the extracted feature maps; and a step of generating a depth map from the disparity map.

The first deep learning network may be trained with a training dataset which is comprised of a left image, a right image, and a disparity map which is generated by using a 3D sensor.

The first deep learning network may include a 1-1 deep learning network for extracting feature maps from the left image, and a 1-2 deep learning network for extracting feature maps from the right image.

The 3D sensor may be a LiDAR sensor.

The disparity map constituting the training dataset may be a map that is converted from a depth map generated through the LiDAR sensor.

The first deep learning network may learn by using transfer learning from a second deep learning network which extracts feature maps from a left image and a right image to generate a disparity map.

A baseline of a first stereo line which generates a left image and a right image to be inputted to the first deep learning network may be smaller than a baseline of a second stereo camera which generates a left image and a right image to be inputted to the second deep learning network.

According to the disclosure, the depth map estimation method may further include a step of generating pseudo-LiDAR data from the generated depth map.

The step of generating the pseudo-LiDAR data may include generating the pseudo-LiDAR data by down-sampling the generated depth map.

According to another aspect of the disclosure, there is provided a depth map estimation system including: an extraction unit configured to extract feature maps from a left image and a right image by using a first deep learning network; a matching unit configured to calculate a disparity map by matching the extracted feature maps; and a generation unit configured to generate a depth map from the disparity map.

According to still another aspect of the disclosure, there is provided a data generation method including: a step of estimating a depth map from a left image and a right image by using a first deep learning network; and a step of generating pseudo-LiDAR data from the estimated depth map.

As described above, according to embodiments of the disclosure, a high-resolution depth map may be estimated from a small baseline-stereo image based on deep learning, by using transfer learning from a deep learning network that is trained to estimate a depth map from a wide baseline-stereo image. Accordingly, in a device which has a small baseline-stereo camera installed therein due to structural constraints, such as a smartphone, a wearable AR/VR device, a drone, 3D image quality can be enhanced.

In addition, according to various embodiments, pseudo-LiDAR data may be generated by using a depth map estimated from a small baseline-stereo image, and may be used for replacing or reinforcing LiDAR data.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view provided to explain a disparity estimation system training method of a stereo camera according to an embodiment of the disclosure;

FIG. 2 is a view illustrating an integration system of a wide baseline-stereo camera and a LiDAR sensor;

FIG. 3 is a view illustrating an integration system of a small baseline-stereo camera and a LiDAR sensor;

FIG. 4 is a view illustrating a depth estimation system of a small baseline-stereo camera;

FIG. 5 is a view illustrating a result of generating a sparse depth map from a dense depth map; and

FIG. 6 is a flowchart provided to explain a depth estimation method of a stereo camera with a small baseline according to another embodiment of the disclosure.

### DETAILED DESCRIPTION

Hereinafter, the disclosure will be described in more detail with reference to the accompanying drawings.

Embodiments of the disclosure provide a depth estimation method for a small baseline-stereo camera through fusion of a LiDAR sensor. The disclosure relates to a technology of transfer learning, which generates a depth map to constitute a training dataset by using a LiDAR sensor, and performs transfer learning from a deep learning network which is trained with a wide baseline-stereo image to a deep learning network which is used for estimating a depth map from a small baseline-stereo image.

Furthermore, embodiments of the disclosure provide a technology which is used in LiDAR applications by using a depth map estimated from a small baseline-stereo image.

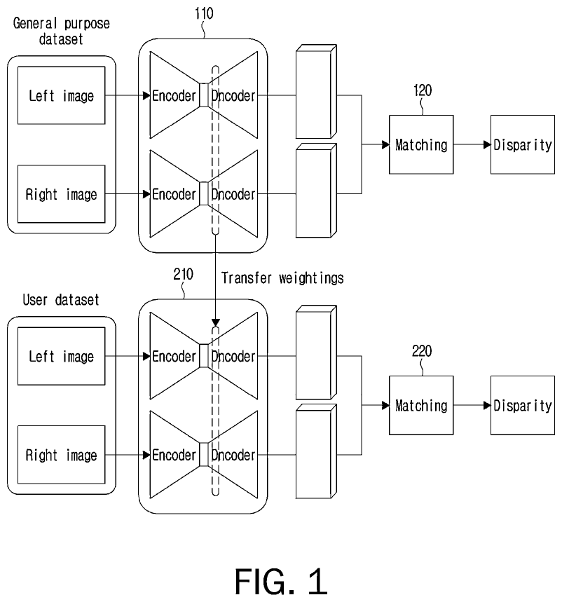

FIG. 1 is a view provided to explain a training method for a depth estimation system of a stereo camera according to an embodiment of the disclosure. In the training method according to an embodiment, transfer learning is performed from a depth estimation model of a wide baseline-stereo camera to a depth estimation model of a small baseline-stereo camera.

FIG. 1 illustrates components included in a depth estimation system of a wide baseline-stereo camera in the upper portion. This system generates a disparity map from a left image and a right image which are shot by the wide baseline-stereo camera.

To accomplish this, a convolutional neural network (CNN) 10 of the depth estimation system of the wide baseline-stereo camera may extract feature maps from the left image and the right image, respectively, and a matching unit 120 may calculate a disparity map by matching the feature map extracted from the left image and the feature map extracted from the right image.

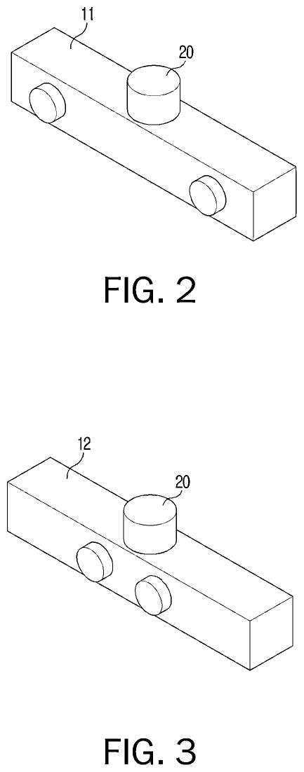

The CNN 110 is trained with a general purpose dataset. The general purpose dataset is comprised of a left image and a right image which are generated by a wide baseline-stereo camera 11, and a disparity map which is generated by using a LiDAR sensor 20 as shown in FIG. 2. The disparity map generated by using the LiDAR sensor 20 may be generated by converting a depth map (LiDAR data) measured by the LiDAR sensor 20.

FIG. 1 illustrates components included in a depth estimation system of a small baseline-stereo camera in the lower portion. This system generates a disparity map from a left image and a right image which are shot by the small baseline-stereo camera.

A CNN 210 of the depth estimation system of the small baseline-stereo camera may extract feature maps from the left image and the right image, respectively, and a matching unit 220 may calculate a disparity map by matching the feature map extracted from the left image and the feature map extracted from the right image.

The CNN 210 performs transfer learning by using the CNN 110. That is, a weighting of the trained CNN 110 is transferred to the CNN 210. Each of the CNN 110 and the CNN 210 may include an encoder and a decoder. Weighting transfer may be performed only for all or some of the layers of the decoder, that is, layers of the front stage, which is illustrated in FIG. 1.

After weighting transfer is completed, the CNN 210 is fine-tuned with a user dataset. The user dataset is comprised of a left image and a right image which are generated by a small baseline-stereo camera 12, and a disparity map which is generated by using a LiDAR sensor 20 as shown in FIG. 3.

The CNN 110 and the CNN 210 may be trained and fine-tuned in such a way that a loss between a disparity map generated by matching extracted feature maps, and a disparity map generated by using the LiDAR sensor 20 is reduced.

A loss function used for training and fine-tuning the CNN 110 and the CNN 210 may use L1 smoothness, which may be expressed by the following equation:

$${ℓ}_{L 1 {smoothness}_{n}} ( pred , target ) = \{ \begin{matrix}0.5 {( {pred}_{n} - {target}_{n} )}^{2} / β , & if \vert {pred}_{n} - {target}_{n} \vert < β \\ \vert {pred}_{n} - {target}_{n} \vert - 0.5 \times β , & otherwise\end{matrix}$$

where Pred is a disparity map which is predicted by the depth estimation system, target is a disparity map which is converted from a depth map of the LiDAR sensor 20, and β is a value from 0 to 1.

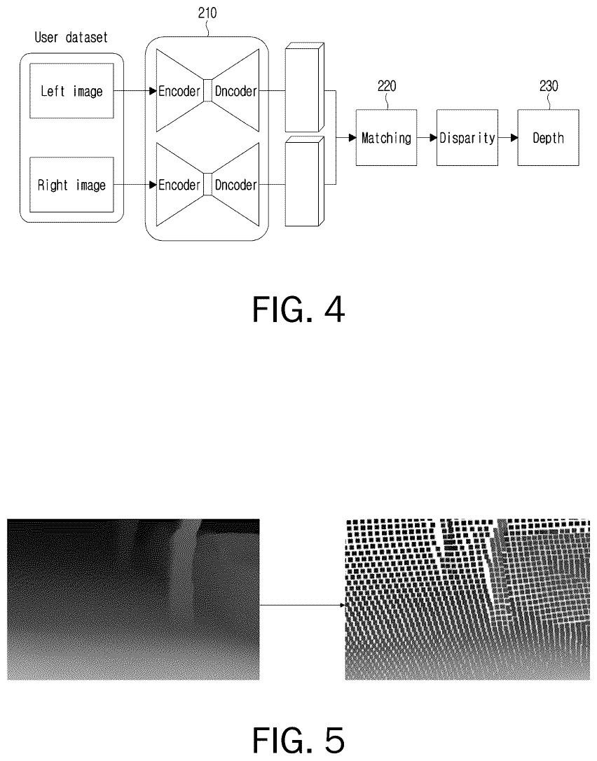

FIG. 4 illustrates a depth estimation system of a small baseline-stereo camera. This system is constituted by connecting a depth conversion unit 230 to the disparity estimation system of the small baseline-stereo camera which performs transfer learning and is fine-tuned as shown in FIG. 1.

The depth conversion unit 230 is configured to generate a depth map by converting a disparity map calculated by the matching unit 220 into a depth map.

The depth map generated by the depth conversion unit 230 is a dense depth map since the depth map is generated based on a stereo image. A sparse depth map may be generated by down-sampling the dense depth map generated by the depth map conversion unit 230. FIG. 5 illustrates a result of generating a sparse depth map (right side) from a dense depth map (left side).

Since the generated sparse depth map is similar to LiDAR data, the sparse depth map may be used as pseudo-LiDAR data. The pseudo-LiDAR data may be used in replacement of real LiDAR data, or may be used to reinforce data by densely up-scaling real LiDAR data.

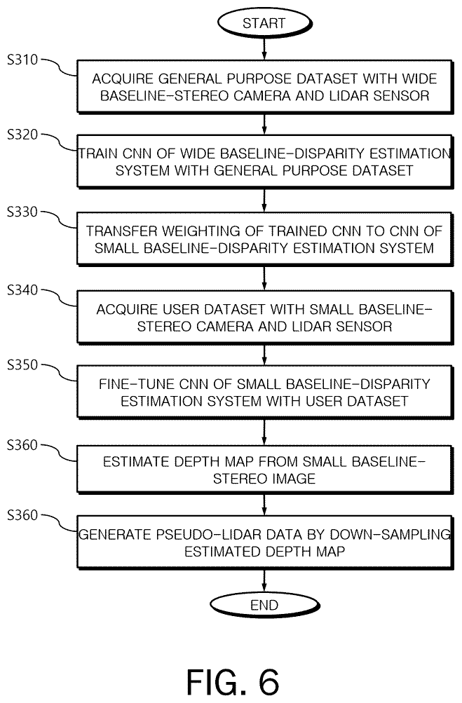

FIG. 6 is a flowchart provided to explain a depth estimation method of a small baseline-stereo camera according to another embodiment of the disclosure.

First, a general purpose dataset for training the disparity estimation system of the wide baseline-stereo camera is acquired by the integration system of the wide baseline-stereo camera 11 and the LiDAR sensor 20 shown in FIG. 2 (S310).

The CNN 110 of the disparity estimation system of the wide baseline-stereo camera is trained with the general purpose dataset acquired in step S310 (S320), and weightings of all layers or some of the layers of the front stage of the decoder of the CNN 110 which completes learning are transferred to the CNN 210 of the disparity estimation system of the small baseline-stereo camera (S330).

Thereafter, a user dataset for fine-tuning the disparity estimation system of the small baseline-stereo camera is acquired by the integration system of the small baseline-stereo camera 12 and the LiDAR sensor 20 shown in FIG. 3 (S340).

The CNN 210 of the disparity estimation system of the small baseline-stereo camera is fine-tuned with the user dataset acquired in step S340 (S350).

A depth map is estimated from a small baseline-stereo image inputted to the depth estimation system shown in FIG. 4, which is established by using the disparity estimation system of the small baseline-stereo camera which completes learning through steps S310 to S350 (S360).

Pseudo-LiDAR data may be generated by converting the depth map estimated in step S360 into a sparse depth map by down-sampling (S370). However, step S370 is optional and is performed when necessary.

Up to now, a depth estimation method of a small baseline-stereo camera through LiDAR sensor fusion has been described in detail with reference to preferred embodiments.

Embodiments of the disclosure provide a technology which estimates a high-resolution depth map from an input to a small baseline-stereo camera, and enhances a LiDAR sensor function or replaces this function by using the estimated depth map.

A small baseline-stereo camera has small change in parameter values, and thus may have a poor depth resolution. To solve this problem, the method of the disclosure estimates a feature map regarding a change in disparity through a deep learning network, and estimates a depth map having a high resolution from the feature map in a small baseline-stereo camera.

Accordingly, a high-resolution depth map can be generated in a device in which a small baseline-stereo camera is installed, such as a wearable AR device, a smartphone, or a robot, so that more realistic services can be provided in the field of games or other industrial fields.

In addition, various applications are possible such that real LiDAR data may be replaced or reinforced with pseudo-LiDAR data.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A depth map estimation method comprising:
a step of extracting feature maps from a left image and a right image by using a first deep learning network;
a step of calculating a disparity map by matching the extracted feature maps; and
a step of generating a depth map from the disparity map.

2. The depth map estimation method of claim 1, wherein the first deep learning network is trained with a training dataset which is comprised of a left image, a right image, and a disparity map which is generated by using a 3D sensor.

3. The depth map estimation method of claim 2, wherein the first deep learning network comprises a 1-1 deep learning network for extracting feature maps from the left image, and a 1-2 deep learning network for extracting feature maps from the right image.

4. The depth map estimation method of claim 2, wherein the 3D sensor is a LiDAR sensor.

5. The depth map estimation method of claim 4, wherein the disparity map constituting the training dataset is a map that is converted from a depth map generated through the LiDAR sensor.

6. The depth map estimation method of claim 4, wherein the first deep learning network learns by using transfer learning from a second deep learning network which extracts feature maps from a left image and a right image to generate a disparity map.

7. The depth map estimation method of claim 6, wherein a baseline of a first stereo line which generates a left image and a right image to be inputted to the first deep learning network is smaller than a baseline of a second stereo camera which generates a left image and a right image to be inputted to the second deep learning network.

8. The depth map estimation method of claim 7, further comprising a step of generating pseudo-LiDAR data from the generated depth map.

9. The depth map estimation method of claim 8, wherein the step of generating the pseudo-LiDAR data comprises generating the pseudo-LiDAR data by down-sampling the generated depth map.

10. A depth map estimation system comprising:
an extraction unit configured to extract feature maps from a left image and a right image by using a first deep learning network;
a matching unit configured to calculate a disparity map by matching the extracted feature maps; and
a generation unit configured to generate a depth map from the disparity map.

11. A data generation method comprising:
a step of estimating a depth map from a left image and a right image by using a first deep learning network; and
a step of generating pseudo-LiDAR data from the estimated depth map.
